(19) United States
(12) Patent Application Publication
(10) Pub. No.: US 2012/0169020 A1
(43) Pub. Date: Jul. 5, 2012

(54) Shopping cart hook attachment for reusable shopping bags

(76) Inventor: Jeffrey Bart Farrell, Ivoryton, CT (US)

(21) Appl. No.: 13/338,662

(22) Filed: Dec. 28, 2011

Related U.S. Application Data
(60) Provisional application No. 61/427,987, filed on Dec. 29, 2010.

(51) Int. Cl. B62D 39/00

(52) U.S. Cl. 280/33.992

(57) ABSTRACT

The shopping cart hook attachment for reusable bags is designed to be attached to vertical surface of metal and or plastic retail shopping carts. The shopping cart hook attachment for reusable bags is comprised of two major components, an inner backer plate and an outer hook component. When installed on a shopping cart the shopping cart hook attachment for reusable bags provides a attachment for a plurality of shopping bags when suspended from it by their carrying handles. This frees up cart space and makes the reusable bags available for use during the checkout process. Surface areas of the shopping cart hook attachment for reusable bags are molded in such a way as to allow the incorporation of advertising or promotional media.

### (b)CROSS-REFERENCE TO RELATED APPLICATIONS

This application is made referencing provisional utility patent application number 61427987 for (a shopping cart hook attachment for reusable bags) filed on Dec. 29, 2010.

### (c)STATEMENT REGARDING FEDERALLY SPONSORED RESEARCH OR DEVELOPMENT

Not Applicable

### (d)THE NAMES OF THE PARTYS TO A JOINT RESEARCH AGREEMENT

Not applicable

### (e)INCORPORATION-BY-REFERENCE OF MATERIALS SUBMITTED ON A COMPACT DISK

Not applicable

### (f)BACKGROUND OF THE INVENTION

(1) Field of the Invention:

The invention generally pertains to the field of structures that temporarily hold reusable shopping bags and more particularly a reusable shopping bag hanger attached to a shopping cart.

(2)Background Art:

In an effort to stem the use of over 500 billion single use shopping bags per year, retailers and municipalities throughout the U.S. and around the world have enacted policies to promote the use of reusable shopping bags. This has created an environment where shoppers, needing to bring reusable bags with them, place the reusable bags into the cart, taking up valuable cart space. Currently, shoppers must use space within or under shopping carts to store their reusable bags. This creates problems for both retailers and consumers. For retailers, valuable cart space is being used for bag storage instead of merchandise. For consumers, reusable bags are often buried underneath merchandise as it is loaded into the shopping cart. This makes the checkout process inconvenient as the shopper must remove a large quantity of items before beginning the bagging process. The present invention also may provide retailers with valuable advertising space.

A search of the prior art did not disclose any literature or patents that read on the claims of the shopping bag hook for reusable shopping bags.

| PATENT NO. | INVENTOR | ISSUED |
|---|---|---|
| 6,450,513 | Bernstein | 17 Sep. 2002 |
| 6,056,178 | Rapp-Duncan | 2 May 2000 |
| 4,069,994 | Wharmby | 24 Jan. 1978 |
| 3,861,633 | Rappleye | 21 Jan. 1975 |
| 3,861,630 | Ady | 21 Jan. 1975 |
| 3,909,034 | Trubiano | 30 Sep. 1975 |

The U.S. Pat. No. 6,450,513 patent discloses a pliable or rigid web securely suspended across a shopping cart to suspend small, delicate and fragile items above the basket of a shopping cart.

The U.S. Pat. No. 6,056,178 patent discloses an auxiliary bin that is secured to a mesh bin of a shopping cart. The auxiliary bin includes a small open grid work for holding small toys, cosmetics, candy, etc, that would fall through the larger openings in the grid of the shopping cart. The auxiliary bin is attachable via a bracket to the grid work of the shopping cart.

The U.S. Pat. No. 4,069,994 patent discloses a bag holder of the type wherein the bag is received and supported by a frame of variable shape. The frame is made of two elements. One element is attached to one side of a frame support, and the other element is attached to an opposite side of the frame support.

The U.S. Pat. No. 3,861,633 patent discloses a hook that is fastened to a metal plate which is bolted to a side of a shopping cart. The hook retains a pocketbook belonging to the user of the cart while shopping. The hook is pivotably mounted so as to swivel in the horizontal plane, and is fitted with a spring to fix the hook in a latched position.

The U.S. Pat. No. 3,861,630 patent discloses an adjustable mounting bar that includes a set of mounting structures for mounting the bar from a support surface. A pair of support fixtures are supported from the bar wherein each support fixture includes an outward portion. A plastic bag has its open end slipped over the outward portions for supporting the bag.

The U.S. Pat. No. 3,909,034 patent discloses a hook means secured rearward of the shopping cart rear wall for supporting articles from the upper area of the cart without interference with the container.

For background purposes and as indicative of the art to which the invention relates, references may be made to the following Design Patent and Patent Application Publication:

Design Patent Number: D618537 Panzer Jun. 29, 2010

Patent Application Publication: Pub. No. U.S. 2010/0219219, Svetina Sep. 2, 2010

### (g)BRIEF SUMMARY OF THE INVENTION

The present invention is a device for mounting on a shopping cart that holds reusable shopping bags and may provide space for advertising.

### (h)BRIEF DESCRIPTION OF THE SEVERAL VIEWS OF THE DRAWINGS

FIG. 1—Right front isometric projection showing—the front hook component of the present invention.

FIG. 2—Left side view of—the front hook component of the present invention.

FIG. 3—Front view of—the hook component of the present invention.

FIG. 4—Rear view of—the hook component of the present invention.

### (i)DETAILED DESCRIPTION OF THE INVENTION

### Description of Parts of the Invention:

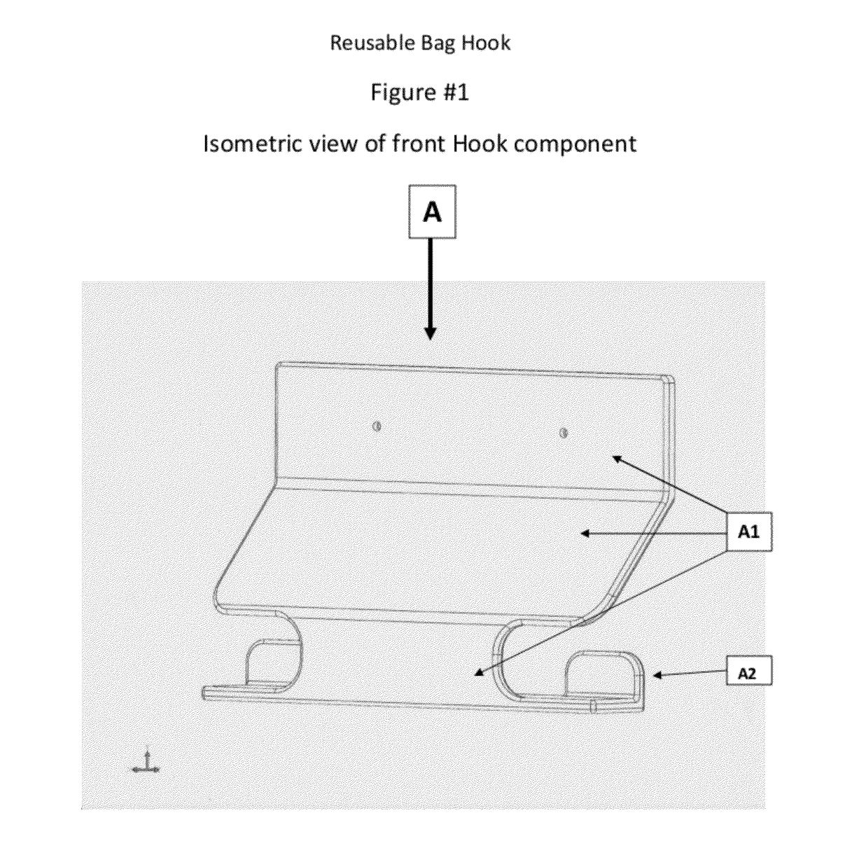

Referring now to the invention in more detail, in FIG. 1, there is shown a hanger device with space for advertising FIG. 1 A1, that is attached to the exterior of the forward facing surface of a shopping cart. The hanger device is secured to the cart through the preexisting apertures of the cart and is secured to the backer plate FIG. 5 B & FIG. 6 B using attachment mechanisms to be determined (i.e. screws, zip ties, rivets and the like).

The construction details of the invention as shown in FIGS. 1-7, are that the present invention may be made of plastic or of any other sufficiently rigid and strong material such as high-strength plastic, metal and the like. Further, the various components of the present invention can be made of different materials.

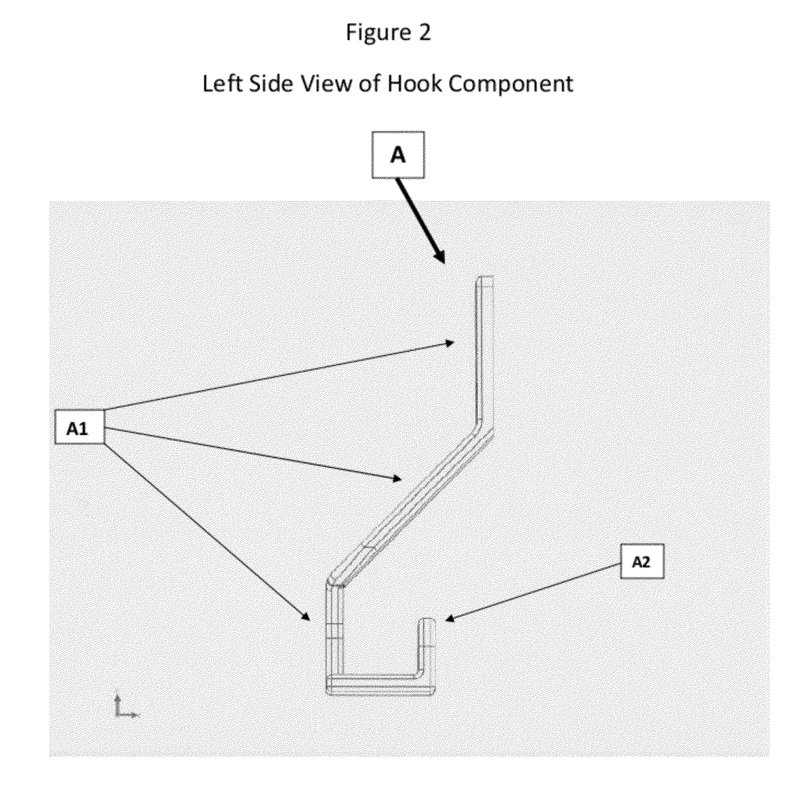

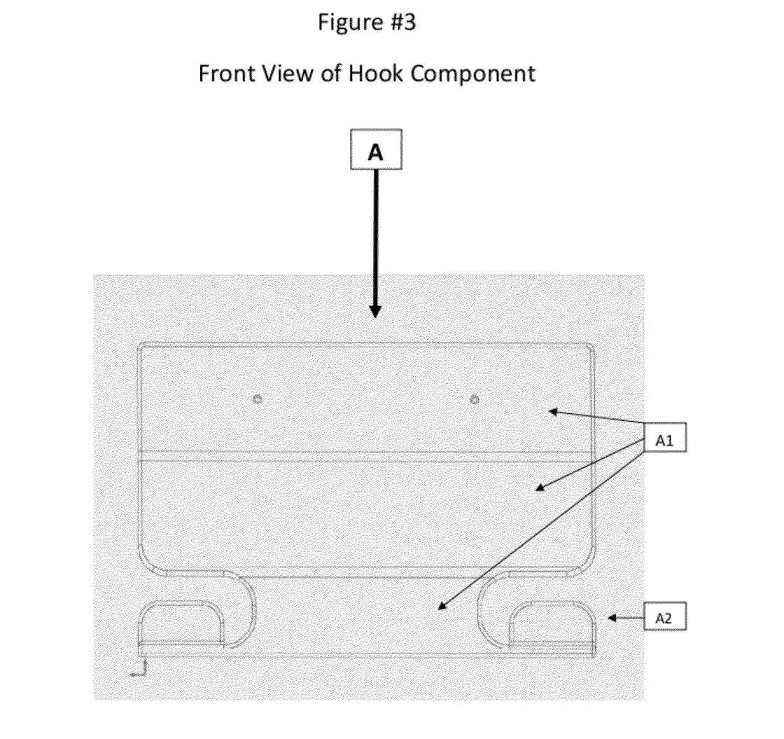

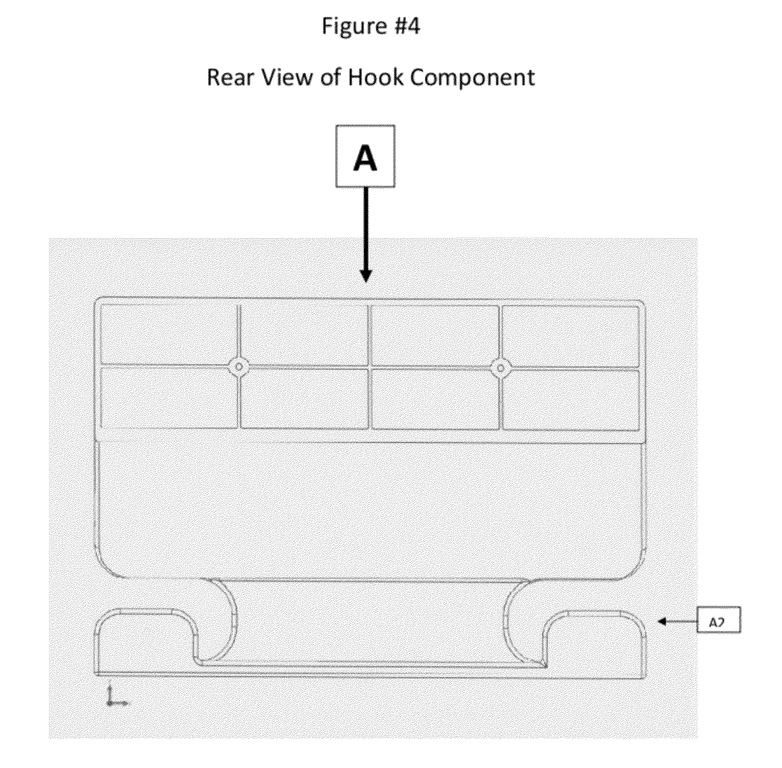

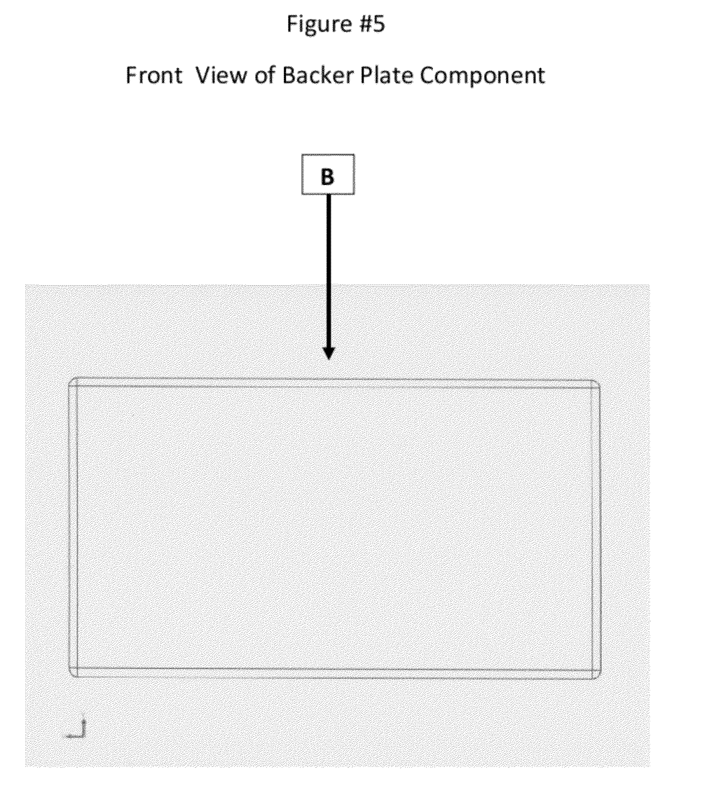

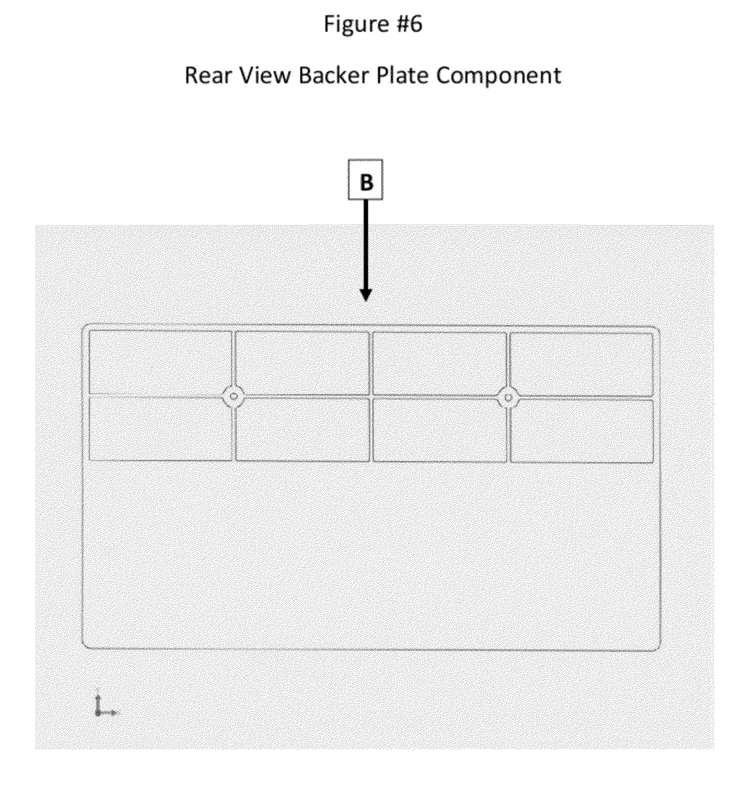

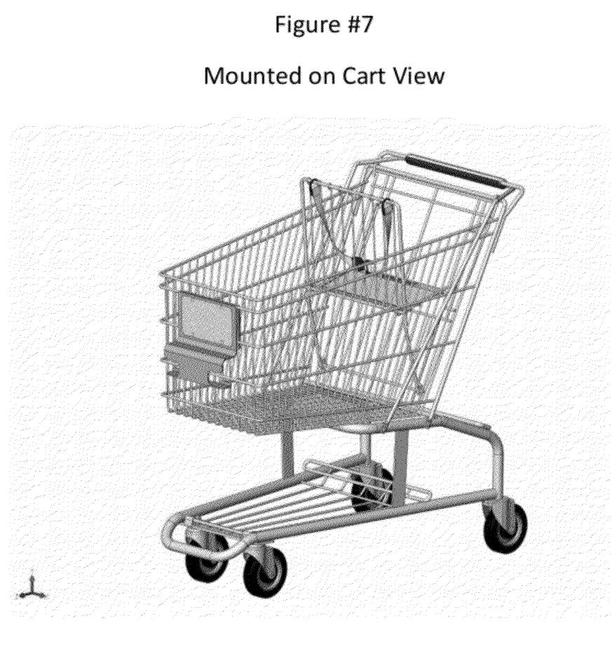

The present invention consists of two elements: a hook component FIG. 1 A, FIG. 2 A, FIG. 3 A & FIG. 4 A and a backer plate FIG. 5 B and FIG. 6 B.

The hook FIG. 1 A, FIG. 2 A, FIG. 3 A and FIG. 4 A is oriented on the vertical as to provide a sufficient mounting surface through the preexisting apertures of the shopping cart to the backer plate element FIG. 5 B & FIG. 6 B.

Not to exclude other possible manufacturing processes the front hook and rear backer plate will be manufactured through the injection molding process. The bottom edge of the hook element FIG. 1 A2 is molded as to create a channel FIG. 1 A2 & FIG. 2 A2 and FIG. 3 A2 of sufficient height and depth to accommodate a plurality of reusable shopping bag handles.

The front hook component is molded in such a way as to provide a surface of sufficient size for accommodating print advertising FIG. 1 A1, FIG. 2 A1 and FIG. 3 A1. The channel component FIG. 1 A2 & FIG. 2 A2 and FIG. 3 A2 is molded in such a way as to reduce the possibility of unwanted items becoming caught on the hook feature. The distance from the backside of the channel FIG. 1 A2 & FIG. 2 A2 and FIG. 3 A2 to the front of the shopping cart when mounted is sufficient to allow access by the handles of the reusable shopping bags.

The second element of the invention is a plate surface FIG. 5 B & FIG. 6 B comprised of a sufficiently rigid material such as plastic or metal and molded in such a way to provide a surface of sufficient size for accommodating print advertising FIG. 5 B. This element is positioned on the interior of forward facing surface of the shopping cart. It attaches to the hook element through the preexisting apertures on the shopping cart using an attachment apparatus to be determined.

### Relationship Between the Parts of the Invention:

The hook component FIG. 1 A, FIG. 2 A, FIG. 3 A & FIG. 4 A, is attached to the backer plate, FIG. 5 B & FIG. 6 B through preexisting apertures on the shopping cart using an attaching apparatus to be determined.

### Description of How the Invention Operates/Functions:

The hook component FIG. 1 A, FIG. 2 A, FIG. 3 A & FIG. 4 A is attached to the exterior of the forward facing surface of a shopping cart. It is secured to the cart through the preexisting apertures of the cart, and is secured to the backer plate FIG. 5 B & FIG. 6 B using an attachment mechanism to be determined. The hook component FIG. 1 A, FIG. 2 A, FIG. 3 A & FIG. 4 A, creates a hanging mechanism for a plurality of reusable shopping bag handles. The Front hook component channel FIG. 1 A2, FIG. 2 A2, FIG. 3 A2 & FIG. 4 A2, is molded in such a way as to reduce the possibility of unwanted items becoming caught on the hook feature.

1. A molded plastic hook to be attached to a vertical surface of a shopping cart to retain reusable shopping bags.
